(19) United States
(12) Patent Application Publication
(10) Pub. No.: US 2009/0150920 A1
(43) Pub. Date: Jun. 11, 2009

(54) System and method for aggregating, distributing, and monetizing the collective wisdom of consumers

(75) Inventor: Courtney Phillips Jones, Fort Myers, FL (US)

Correspondence Address: TIMOTHY P. O'HAGAN, 8710 KILKENNY CT, FORT MYERS, FL, 33912, US

(73) Assignee: LOYAL TV INC, Fort Myers, FL (US)

(21) Appl. No.: 12/001,141

(22) Filed: Dec. 10, 2007

(51) Int. Cl. H04N 7/16

(52) U.S. Cl. 725/23

(57) ABSTRACT

A networked system collects, aggregates, and distributes the collective wisdom of consumers. An aggregation module obtains, from each of a plurality of reviewing consumers: i) a file comprising a motion video clip depicting a video product review of a product; and ii) the reviewing consumer's indication of at least one categorization data element identifying the product. A motion video clip database stores each motion video clip. A search database stores, for each motion video clip, the at least one product categorization data element identifying the product depicted in the motion video clip. A search module receives a search term from a searching consumer and identifies a selected group of video product reviews. The selected group of video product reviews comprises those video product reviews that are a relevant video product review. A relevant video product review comprises a video product review that is associated with a product categorization data element corresponding to the search term. A monetization module debits a first predetermined value from a merchant's account upon each occurrence of a target event. The target event may comprise the searching consumer initiating interaction with a link associated with web content comprising additional information about the product depicted in the video product review.

### TECHNICAL FIELD

The present invention relates to a network based system for aggregating, distributing, and monetizing the collective wisdom of consumers and, more particularly to a network based system for collecting consumer video product reviews, categorizing video product review content, associating video product review content with monetization events, and distributing video product review content.

### BACKGROUND OF THE INVENTION

The process and communication media through which consumers develop knowledge of products and services available in the market place and make purchase decisions has evolved over the years.

In the earliest days—even prior to the invention of the printing press—consumers had choices of products available from various vendors in a local market. In such an environment, a local “word of mouth” network was the only means by which a consumer could become aware of products and make purchasing decisions.

More specifically, a consumer could interact with other consumers in the market place, typically by oral communication, to gather information about a product, a product's attributes, a product's price, and a product's availability with other consumers who have knowledge of the product or have already purchased the product or similar products. A consumer could also discuss the product, its attributes, its price, and its availability directly with a vendor selling the product. Similarly, the local “word of mouth” network was the only means by which a vendor could disseminate information about his or her products. The scope of other consumers and vendors known to an individual and the accuracy of conveying information through multiple levels of oral communication significantly limits information that can be disseminated by a vendor and information available to a consumer.

The invention of the printing press provided the first means for mass communication. A major advantage of communicating message content by printed media over communication by a “word of mouth” network is that message content, once printed, can be distributed accurately to people well beyond those to which a message can be accurately delivered by a “word of mouth” network.

Along with printed media came the first notion of advertising. A vendor could provide information about the vendor and/or product to consumers by including advertisement content or an advertisement message in a printed publication. Because the vendor's message remains static once printed, the message is accurately communicated with any potential consumer reading the publication—without distortion which is typical in a “word of mouth” network.

The message content about a product, its attributes, its price, and/or its availability can be significantly different when delivered to a potential consumer through advertisement than when gathered by a consumer through “word of mouth” market place interaction. First, advertisement content is almost always controlled by the vendor. Therefore, the advertisement content is typically crafted to induce a purchase and not necessarily to educate the consumer. As such, a disadvantage of information disseminated through advertisement content over information gathered by a consumer through a “word of mouth” network is that the advertisement content is often “filtered” such that only the most favorable aspects of the vendor or product are included in the advertisement.

More modern mass communication media such as radio and television transmission have accelerated both the advantages and disadvantages of providing information about vendors and/or products to consumers through media advertising versus consumers acquiring such knowledge through a “word of mouth” network.

With these modern mass communication media, the advertiser's content or message can be distributed to vastly more people. Further, audio and video media formats available for delivery of a message through radio or television can be more effective for delivery to brief “sound bite” messages typically characteristic of advertising. Because of the vast reach of radio and/or television advertising and the effectiveness of the audio and/or video media, it is commercially feasible for advertisers to hire professional advertising agencies to craft the advertisement content. These professionals are able to more carefully “filter” the content so that only the most favorable aspects of the vendor or product are included in the advertisement and create a delivery of the content deliberately intended to drive an emotional or impulse purchase decision.

With the proliferation of advertisement, consumers have become aware that the message content is crafted by the advertiser for purposes of inducing a purchase—not necessarily educating the consumer. As such, there is a level of skepticism or even distrust—a notion that the advertisement content was developed as a paid endorsement of the product or services. Many advertisements even include disclosure language specifying that the advertisement includes a “paid endorsement” or that “results are not typical” by a “paid liar”. This skepticism or distrust brings the natural result that while mass distributed advertisement is effective for making a consumer aware of a vendor and/or a product and, although intended to induce a purchase, is less effective for inducing a purchase because a distrusting consumer often looks elsewhere for information to educate himself or herself before making a purchase decision.

More recently, on-line search advertisement placement has become a major media outlet for advertisement. An online search advertisement placement is materially different than a print placement or a traditional (and for a long time regulated) 30 or 60 second radio or TV spot. Typically, a print placement or a radio or TV spot is a stand alone message to the consumer. If the consumer retains any information, it is information that is included in the print placement or the radio or TV spot.

However, with on-line search advertisement placement the stand alone content included in the advertisement is not necessarily intended to be the entire message to the consumer. Upon clicking through an on-line search advertisement, a consumer will typically be directed to far more extensive content regarding the vendor or product described in the advertisement. Therefore, the purpose of the on-line advertisement placement is to induce the consumer to link to the extensive content and the effectiveness of an on-line advertisement campaign can be measured in terms of the percentage of advertisement placements that yield “clicks” through to the extensive content.

To a limited extent, on-line search advertisement placement shares one of the same communication aspects that make the “word of mouth” network an effective means for a consumer to learn information about a vendor or product. When a consumer interacts with other consumers in the market place, the consumer is actively seeking information about a vendor or product. With on-line advertisement, if the consumer “clicks” through to the extensive content, the consumer is seeking information by actively following hyperlinks to the information.

Behavioral studies have shown that people retain information better if it is sought versus simply made available. As such, the portion of the extensive content that is retained by the user is likely higher than if that same information content had been placed in a print advertisement placement or a radio or TV spot—simply because the consumer sought it out rather than having it presented.

Additionally, it is well known in the on-line advertisement industry that on-line advertisement placements are much more effective when targeted towards consumers who are already in need for information of the type available if the advertisement placement is clicked. As such, companies such as GOOGLE have had significant success placing on-line advertisements related to sought after key word topics. In more detail, the topic may be derived from search terms that are input by the user such that the on-line advertisement placement presented to the user includes content (and links to extensive content) related to the search term.

This distinction in effectiveness between modern print, radio, and TV advertisements versus on-line advertisement placements plays out in empirical evidence also. A major brand of automobiles sold in the US recently disclosed in Forbes® magazine that its $700 million advertising budget represents approximately $900 per vehicle sold. That is several percentage points of gross revenue per vehicle. With this size advertising budget, the company utilizes various research and modeling tools to structure advertising campaigns, and validate the effectiveness of campaigns, in each phase of a “purchase funnel” from “awareness of the brand”, to “including the brand for purchase consideration”, to a “decision/action”. The company has discovered that TV and print ads are effective in the early stages of the purchase funnel—“awareness of the brand” and “including the brand for purchase consideration”. However, the company also discovered that on-line advertising is much more effective with consumers closer to making a final purchase decision.

This empirical discovery correlates well with the theory. The wide distribution of advertisement content by print and TV reaches a vast quantity of people and results in brand awareness and inducing people to consider the brand for a purchase decision. The placement of on-line advertisements reach fewer people, however, the depth of the information content available to an inquiring consumer who links through the advertisement placement to the advertiser's web site—and the amount of information that is retained by virtue of the consumer seeking such information—is much more effective for delivering the messages that induce a final purchase decision.

Even though online advertising enables an advertiser to deliver a more sophisticated content and even though consumer retention of the content is typically higher because the consumer is actively seeking the content, online advertising still lacks other benefits of marketplace interaction. First, the consumer is still aware that the content is provided by the advertiser and is intended to induce a purchase and not necessarily to educate the consumer. Secondly, there is very little dialog between the advertiser and the consumer. While some web-sites may include chat dialog systems—these are not effective means for a consumer to obtain significant and in-depth additional information. Thirdly, other than if a brand's web site includes a message board or a vendor scoring system, there is little opportunity to interact with other consumers or benefit from the knowledge, experience, or wisdom of other consumers familiar with the brand.

In view of the foregoing, what is needed is a system and method for aggregating and distributing the knowledge, experience and wisdom of consumers. Further, it is preferable that such system distribute such knowledge, experience, and wisdom in an effective manner to consumers seeking such information. Further yet, it is preferable that such system also monetize such knowledge, experience, and wisdom for purposes of making such a system commercial feasible to implement.

### SUMMARY OF THE INVENTION

A first aspect of the present invention comprises a networked system for collecting, aggregating, and distributing the collective wisdom of consumers. The networked system may include a web server for establishing a plurality of internet connections, each with a client system. An authentication module associates each internet connection of a client system with one of a plurality of registered consumers.

An aggregation module obtains, from each of a plurality of reviewing consumers (each reviewing consumer being a registered consumer): i) a file comprising a motion video clip depicting a video product review of a product; and ii) the reviewing consumer's indication of at least one categorization data element identifying the product.

A motion video clip database stores each motion video clip and a search database stores, for each video product review, the at least one product categorization data element identifying the product depicted in the motion video clip.

A search module receives a search term entered by, or associated with a searching consumer (the searching consumer may also be a registered consumer) and identifies a selected group of video product reviews. The selected group of video product reviews comprises those video product reviews that are relevant video product reviews. A relevant video product review comprises a video product review that is associated with a product categorization data element corresponding to the search term.

A monetization module may debit a first predetermined value from a merchant or advertiser's account upon each occurrence of a monetization event. Exemplary monetization events may associate with and/or include viewer interaction with links associated with additional information about the product depicted in the video product review. Examples include the viewer clicking on an advertisement associated with the product and/or viewer entry into a customized brand world associated with the product for premium interaction.

Other monetization events may include various premium interaction events within a brand world and/or user selection of a particular product or brand for further information or purchase. Yet other monetization events may comprise the viewer initiating purchase of the product depicted in the video product review by interaction with a link associated with a merchant's purchase offer. The merchant's purchase offer may comprise: i) a buy it now offer specifying a price; and/or ii) an electronic coupon offer specifying a discount.

In one sub embodiment, the web server further provides a search results web page to the searching consumer. The search results web page may comprise at least two distinct search result listings. A first of the at least two distinct search result listings comprises identification of at least a portion of the selected group of video product reviews. A second of the at least two distinct search result listings comprises one of: i) identification of a plurality of brand names associated with the search term; and ii) identification of a plurality of product names associated with the search term.

In a second sub embodiment, the web server further provides a search results web page to the searching consumer. The search results web page comprises at least three distinct search result listings. A first of the at least three distinct search result listings comprises identification of at least a portion of the selected group of video product reviews. A second of the at least three distinct search result listings comprises identification of a plurality of brand names associated with the search term. And, a third of the third of the at least three distinct search result listings comprises identification of a plurality of product names associated with the search term.

In a third sub embodiment, the system may further comprise a rewards module. The rewards module may credit a second predetermined value to the reviewing consumer's account upon occurrence of the target event. The target event may be the searching consumer selecting for viewing a reviewer's video product review and/or a monetization event associated with the reviewer's video product review.

In a fourth sub embodiment, the system may further comprise a review effectiveness database storing, for each video product review; at least one effectiveness parameter identifying a frequency at which the video product review, when viewed by registered consumers, induces occurrence of the target event and/or the monetization event.

In this sub embodiment, the selected group of video product reviews may comprise those video product reviews which are both a relevant video product review and an effective video product review. An effective video product review comprises a video product review that is associated with an effectiveness parameter identifying that the video product review induces the target event with a frequency greater than a threshold frequency.

In yet a fifth sub embodiment, the system may further comprise a registered user database storing, in association with identification of each of the plurality of registered consumers, viewer response characteristic data. The viewer response characteristic data may identify at least one video characteristic which, when present in a video product review viewed by the registered consumer, induces the registered consumer to take an action resulting in occurrence of the target event with a greater frequency then when the video characteristic is not present.

In this fifth sub embodiment, the review effectiveness database further stores, in association with each video product review, a characteristic rating parameter identifying an extent to which the video characteristic is present in the video product review.

Further, in this fifth sub embodiment, the selected group of video product reviews comprises those video product reviews that are both a relevant video product review and an effective video product review and further are associated with a characteristic rating parameter indicating that the extent to which the video characteristic is present in the video product review is above a predetermined threshold.

The characteristic rating parameter may be a value representative of at least one other registered consumer's opinion of the extent to which the video characteristic is present in the video product review.

Further, the characteristic rating parameter may be tracked based on demographic classes of consumers such that, the characteristic rating parameter may be a value representative of an opinion, of at least one other registered consumer selected from a subgroup consisting of only a portion of the plurality of registered consumers, of the extent to which the video characteristic is present in the video product review. Those registered consumers within the sub group consists of only those registered consumers that demographically similar to (e.g. share at least one target demographic attribute with) the searching consumer.

Two exemplary video characteristics include: i) informational detail about the product; and ii) humorous content. As such, the characteristic rating parameter may be a value representative of at least one other registered consumer's opinion of the extent to which information detail is present in the video product review or the extent to which there is humorous content present in the video product review. These video characteristics are for example only. Other video characteristics may be also be peer rated by other registered consumers and the tracked.

A second aspect of present invention also comprises a networked system for collecting, aggregating, and distributing the collective wisdom of consumers. Again, the networked system comprises a web server for establishing a plurality of internet connections, each with a client system, and an authentication module associating each internet connection with one of a plurality of registered consumers.

A motion video clip database stores a plurality of files, each comprising a motion video clip depicting a video product review of a product. A search database stores, for each video product review, at least one product categorization data element identifying the product.

A review effectiveness database stores, for each video product review; at least one effectiveness parameter identifying a frequency at which the video product review, when viewed by registered consumers, induces occurrence of a target event.

A search module receives a search term associated with a searching consumer (one of the registered consumers) and identifies a selected group of video product reviews. The selected group of video product reviews comprises those video product reviews that are both a relevant video product review and an effective video product review. A relevant video product review comprises a video product review that is associated with a product categorization data element corresponding to the search term. And, an effective video product review comprises a video product review that is associated with an effectiveness parameter identifying that the video product review induces the target event with a frequency greater than a threshold frequency.

Again, in a first sub embodiment, the web server further provides a search results web page to the searching consumer and the search results web page comprises at least two distinct search result listings. A first of the at least two distinct search result listings comprises identification of at least a portion of the selected group of video product reviews. A second of the at least two distinct search result listings comprises one of: i) identification of a plurality of brand names associated with the search term; and ii) identification of a plurality of product names associated with the search term.

In a second sub embodiment, the web server further provides a search results web page to the searching consumer and the search results web page comprises at least three distinct search result listings. A first of the at least three distinct search result listings comprises identification of at least a portion of the selected group of video product reviews. A second of the at least three distinct search result listings comprises identification of a plurality of brand names associated with the search term. And, a third of the third of the at least three distinct search result listings comprises identification of a plurality of product names associated with the search term.

The target event may be a monetization event and exemplary monetization events may include viewer interaction with a link associated with additional information about the product depicted in the video product review such as the viewer clicking on an advertisement associated with the product and/or viewer entry into a customized brand world associated with the product for premium interaction. Other monetization events may include various premium interaction events within a brand world and/or user selection of a particular product or brand for further information or purchase. Yet other monetization events may comprise the viewer initiating purchase of the product depicted in the video product review by interaction with a link associated with a merchant's purchase offer. The merchant's purchase offer comprises: i) a buy it now offer specifying a price; and/or ii) an electronic coupon offer specifying a discount.

In a third sub embodiment, the system may further comprise a registered user database. The registered user database may store, in association with identification of each of the plurality of registered consumers, viewer response characteristic data.

The viewer response characteristic data may identify at least one video characteristic which, when present in a video product review viewed by the registered consumer, induces the registered consumer to take an action resulting in occurrence of the target event with a greater frequency then when the video characteristic is not present.

In this third sub embodiment, the review effectiveness database may further store, in association with each video product review, a characteristic rating parameter identifying an extent to which the video characteristic is present in the video product review.

Further, in this third sub embodiment, the selected group of video product reviews may comprise those video product reviews that are both a relevant video product review and an effective video product review and further are associated with a characteristic rating parameter indicating that the extent to which the video characteristic is present in the video product review is above a predetermined threshold.

Again, the characteristic rating parameter may be a value representative of at least one other registered consumer's opinion of the extent to which the video characteristic is present in the video product review.

Again, the characteristic rating parameter may be tracked based on demographic classes of consumers such that the characteristic rating parameter may be a value representative of an opinion, of at least one other demographically similar registered consumer, of the extent to which the video characteristic is present in the video product review. The demographically similar registered consumer may be one of the plurality of registered consumers with demographic characteristics similar to those of the searching consumer.

A third aspect of the present invention also comprises a networked system for collecting, aggregating, and distributing the collective wisdom of consumers. The networked system comprises a web server for establishing a plurality of internet connections, each with a client system. Again, an authentication module associates each internet connection with one of a plurality of registered consumers.

An aggregation module may be adapted for obtaining, from each of a plurality of reviewing consumers, a file comprising a motion video clip depicting subject matter related to a merchant's product.

A motion video clip database stores each motion video clip. A search database stores, for each motion video clip, at least one product categorization data element identifying the subject matter related to the merchant's product depicted in the motion video clip.

A search module receives a search term associated with a searching consumer and identifies at least one relevant motion video clip. A relevant motion video clip comprises a motion video clip that is associated with a product categorization data element corresponding to the search term.

A monetization module is adapted for: i) associating a monetization value with a first target event, and ii) debiting the monetization value from a merchant's account upon each occurrence of the first target event. The first target event may comprise the searching consumer viewing the motion video clip comprising subject matter related to the merchant's product.

A rewards module credits a reward value to an account of the reviewing consumer upon each occurrence of the first target event. The reward value may be less than the monetization value.

In one sub embodiment, the monetization module is further adapted to: i) associate a second monetization value with a second target event, and ii) debiting the second monetization value from the merchant's account upon each occurrence of the second target event. The second target event may comprise the searching consumer initiating interaction with a link associated with web content comprising additional information about the merchant's product.

In this sub embodiment, the rewards module may further credit a second reward value to the account of the reviewing consumer upon each occurrence of the second target event. The second reward value may be less than the second monetization value. The link may be associated with an advertisement placement for the merchant's product.

Alternatively, the second target event may be the searching consumer initiating purchase of the merchant's product by interaction with a link associated with a purchase offer of the merchant. The purchase offer may be in the form of: i) a buy it now offer specifying a price; and ii) an electronic coupon offer specifying a discount.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a block diagram representing exemplary architecture for implementing a network based system for aggregating, distributing, and monetizing the collective wisdom of consumers in accordance with an embodiment of the present invention.

FIG. 2 is a diagram representing a plurality of video product reviews in accordance with an embodiment of the present invention;

FIG. 3 is a table representing exemplary data relationships for categorizing video product reviews for convenient searching, browsing, and viewing in accordance with an embodiment of the present invention;

FIG. 4 is a diagram representing exemplary data relationships for categorizing video product reviews for convenient searching, browsing, and viewing in accordance with an embodiment of the present invention;

FIG. 5 is a diagram representing an exemplary web document useful for searching, browsing, and viewing in accordance with an embodiment of the present invention;

FIG. 6 is a diagram representing an exemplary web document useful for searching, browsing, and viewing in accordance with an embodiment of the present invention;

FIG. 7 is a diagram representing an exemplary web document useful for searching, browsing, and viewing in accordance with an embodiment of the present invention;

FIG. 8 is a diagram representing an exemplary web document useful for searching, browsing, and viewing in accordance with an embodiment of the present invention;

FIG. 9 is a diagram representing exemplary monetization events in accordance with an embodiment of the present invention;

FIG. 10 is a diagram representing exemplary reward events in accordance with an embodiment of the present invention;

FIG. 11 is a more detailed block diagram representing exemplary architecture for implementing a network based system for aggregating, distributing, and monetizing the collective wisdom of consumers in accordance with an embodiment of the present invention;

FIG. 12 is a diagram representing an exemplary web document useful for uploading and categorizing a video product review in accordance with an embodiment of the present invention;

FIG. 13 is a diagram depicting an exemplary alternative process for categorizing a video product review in accordance with an embodiment of the present invention;

FIG. 14 depicts a flow chart representing exemplary operation of a feed module in accordance with an embodiment of the present invention;

FIG. 15 depicts a table representing exemplary request events and request parameters that may be passed to a feed module in accordance with an embodiment of the present invention;

FIG. 16 depicts a table useful for selecting at least one video product reviews for rendering to a consumer in accordance with an embodiment of the present invention;

FIG. 17 depicts exemplary data relationships of video effectiveness data in accordance with an embodiment of the present invention;

FIG. 18 depicts exemplary data relationships for authentication, demographic, purchase pattern and viewer response characteristic data that may be associated with a consumer in accordance with an embodiment of the present invention;

FIG. 19 is a diagram representing an exemplary web document useful for obtaining video characteristic data in accordance with an embodiment of the present invention; and

FIG. 20 depicts a table useful for reward accounting in accordance with an embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

It should also be appreciated that table structures represented in this application are exemplary only and intended to show the mapping of relationships between various data elements. Other table structures may store similar data elements in a manner that maintains the relationships useful for the practice of the present invention.

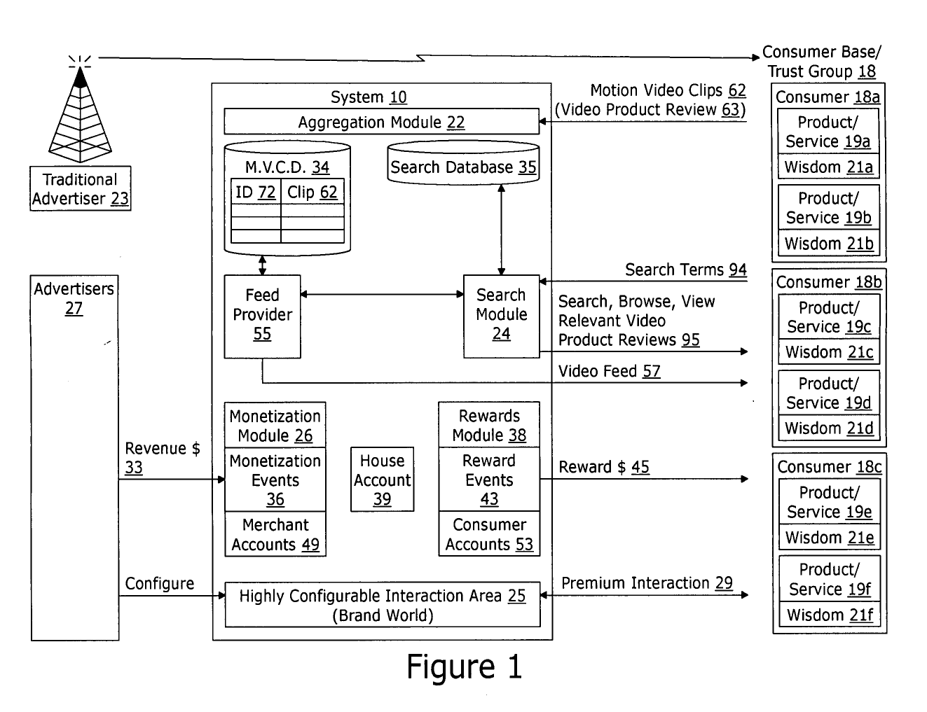

FIG. 1 represents an overview of a networked system 10 for collecting, aggregating, distributing, and monetizing the collective wisdom of consumers 18a, 18b, and 18c which, in the aggregate, represent a consumer base or trust group 18.

It is recognized that each consumer (for example consumer 18a) has experience with, or related to, certain products and services (for example product 19a and product 19b) and/or experience with subject matter with which the products or services relate. Based on such experience, each consumer has an opinion, technical information, or other information useful to other potential consumers of such product (e.g. wisdom 21a and wisdom 21b).

It is recognized that, with education and/or some encouragement provided by a traditional advertiser 23 such as a television broadcast station, a radio broadcast station, or even print or on-line media, consumers 18a, 18b, and 18c are willing to share their wisdom 21 about the products or services 19 (or the subject matter with which the precuts or services 19 relate) with other potential consumers. More specifically, consumers 18a, 18b, and 18c are willing to provide motion video clips 62 depicting themselves sharing their wisdom 21 regarding a product 19 (or the subject matter with which the precuts or services 19 relate) in the form of a video product and/or brand review—each of which may be generically referred to as a video product review 63.

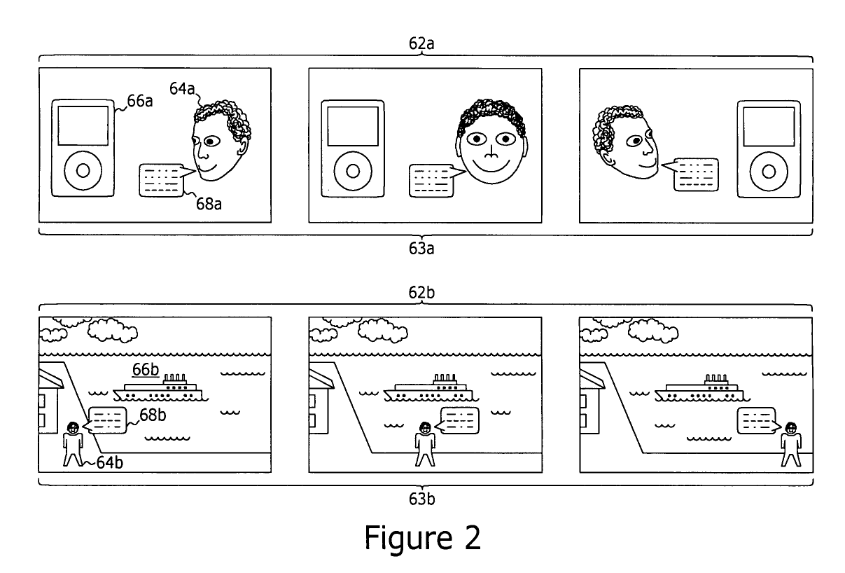

In more detail, and referring briefly to FIG. 2, each motion video clip 62a, 62b comprises a plurality of frames depicting a person sharing his or her wisdom regarding an identified product service or brand (or wisdom regarding subject matter related to a product service or brand)—which may be in the form of a video product review 63a, 63b. For example, motion video clip 62a may represent person 64a providing his/her video product review 63a of a “Brand X” MP3 music player (product 66a). The video product review 63a may be presented as a combination of spoken audio 68a uttered by the person 64a, facial expressions of the person 64a depicted within the motion video clip 62a, and/or depictions of the product 66a itself.

Similarly, motion video clip 62b may represent a person 64b sharing his or her wisdom related to any of a “Brand X” cruise line and/or a particular cruise destination (product 66b). Again, the motion video clip 62b may include the product review 63b as a combination of spoken audio 68b uttered by the person 64b, facial expressions of the person 64b depicted within the motion video clip 62b, and/or depictions of the product 66b itself.

Returning to FIG. 1, an aggregation module 22 obtains each motion video clip 62 (uploaded by a consumer 18). Each motion video clip 62 is then stored in a motion video clip database 34 and associated with a unique motion video product review ID 72. The motion video clip 62, or more specifically the video product review 63 depicted therein, is categorized in a search database 35.

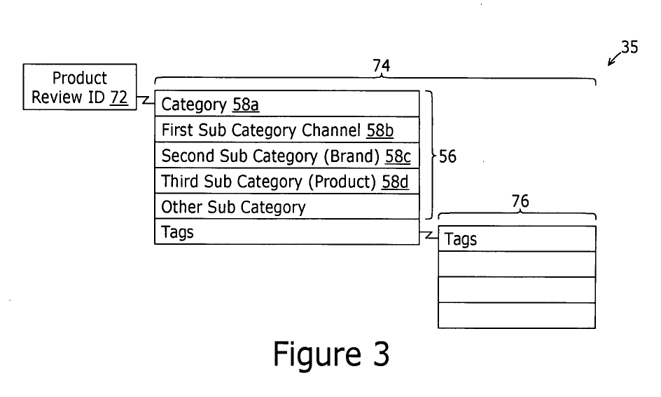

Turning briefly to FIG. 3, the search database 35 may associate the unique motion video product review ID 72 with a plurality of content descriptors 74 which categorize the video product review 63 depicted in the motion video clip 62 utilizing a combination of categories and subcategories 56—including text tags 76 which may further describe and/or relate to the video product review 63.

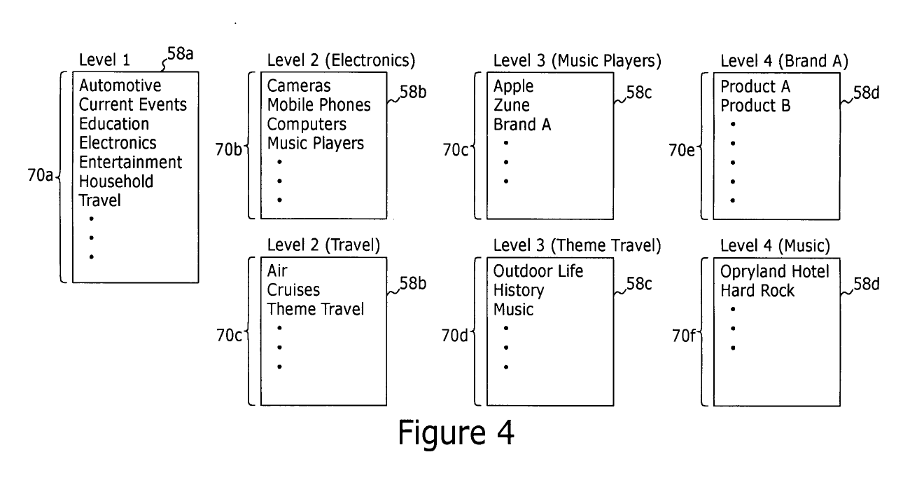

For example, turning briefly to FIG. 4 in conjunction with FIG. 3, a first level (e.g. highest level) categorization 58a (also referred to as a channel) may distinguish video product reviews 63 by a product class, industry, or subject matter (for example, automotive, electronics, travel etc).

A second level of categorization 58b, under each first level of categorization 58a may further categorize by type of product or subject matter. For example, second level categorization 58b under the first level classification of “Electronics” may include sub categories such as cameras, cell phones, computers, music players, and etc). Similarly, a second level of categorization 58b under the first level classification of “Travel” may include sub categories such as airlines, cruises, and etc.

A third level of categorization 58c, under each second level of categorization 58b may further categorize by brands. For example, third level categorization 58c under the second level categorization of “Music Players” may include various brands of music players. Similarly, a third level of categorization 58c under the second level categorization of “Theme Travel” may include sub categories such as themes of travel.

A fourth level of categorization 58c, under each second level of categorization 58b may further categorize by specific products and/or subject matter. For example, fourth level categorization 58d under a specific third level brand of music players may include the products available by such brand. Similarly, a fourth level of categorization 58d under a music category of “Theme Travel” may hotels, restaurants, or other travel related products and/or services applicable to music.

In this example, video product review 63a depicted in video clip 62a (FIG. 2) may be classified under “Electronics” and subcategorized under “Music Players”. Similarly, video product review 63b depicted in video clip 62b (FIG. 2) may be classified under “Travel” and subcategorized under “Cruises”.

It should be appreciated that although FIG. 4 depicts only four levels of categorization, it is envisioned that other levels of categorization may further subcategorize subject matter by company, brand, make, model, source of the product, and/or text tags related to any of the company, brand, make, model, source of the product, or subject matter.

It should be appreciated that selection of a particular structure for storing and/or categorizing each video product review 63 utilizing content descriptors 74 within the search database 35 is a matter of design choice and the data relationships depicted in FIG. 3 and FIG. 4 are only one exemplary implementation depicted for purposes of illustrating the present invention.

Returning again to FIG. 1, a consumer 18 may search, browse and view video product reviews 63 that relates to any product, service, or subject matter desired by, or of interest to, the searching consumer (referred to as a relevant video review 95).

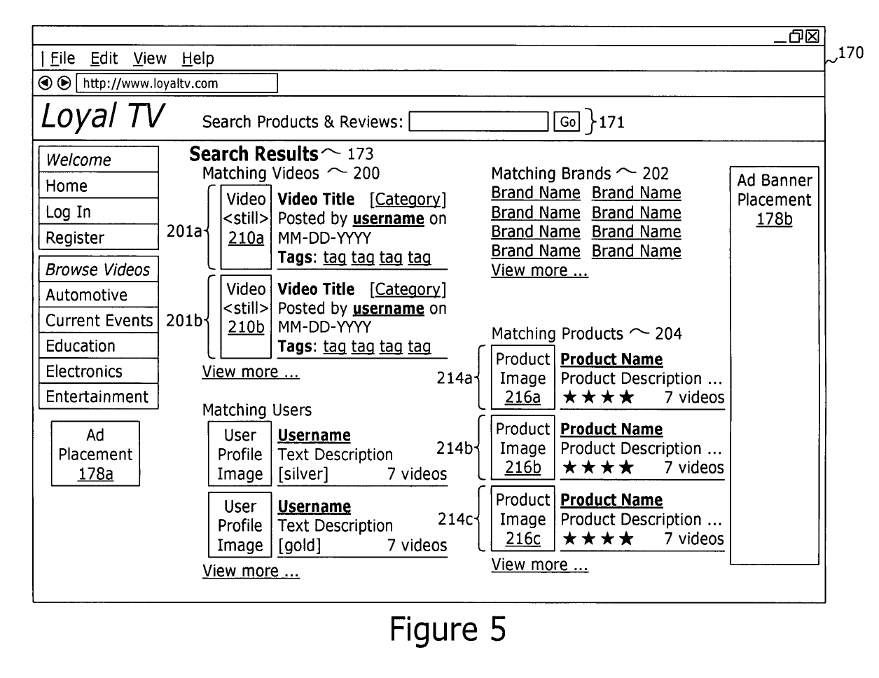

Turning briefly to FIG. 5 in conjunction with FIG. 1, an exemplary web page 170 may include a search control 171 for obtaining user entered search terms 94. A search module 24 may populate the web page 170 with search results 173 which may be structured as links for further searching, browsing, and/or viewing one or more relevant video reviews 95.

The search results web page 170 may include at least two or three distinct search result listings. A first of the result listings may comprise matching videos 200, a second of the result listings may comprise matching brands 202, and a third of the result listings may comprise matching products 204. The exemplary search results web page 170 may further include at least one ad placement 178a-178b. Selection of advertisement content for rendering in each ad placement 178a, 178b is discussed in more detail herein.

Matching videos 200 may comprise a summary 201a, 201b of those relevant video product reviews 95 that are associated with product content descriptors 74 (FIG. 3) that best match the search terms 94 entered by the user. Each summary 201a, 201b may comprise a thumbnail 210a, 210b of a portion of the video product review, a title of the video product review, identification of the reviewing registered user (by user name for example), a date of the review, and text tags associated with the review. The text tags may be active links which, if activated, initiate a new search with the new search term being the text tag.

Matching brands 202 may comprise a listing of each brand name that associates with any of the search terms 94 entered by the user. More specifically, the listing may include any brand name with a data association within the search database 35 which indicates that such brand is associated with any search term 94 or associated with a product or service associated with any search term 94.

Those brand names that include a more relevant association with a search term 94, an association with multiple search terms 94, or higher probability of association with a search term may be depicted more prominently within the matching brands 202. Alternatively, placement of a brand name within the matching brands 202 may be a monetization event 36 (FIG. 1) and an advertiser(s) (or merchant(s)) 27 (FIG. 1) associated with a brand may pay to have its brand name depicted more prominently within matching brands 202 for certain search terms 94.

As an example, referring to FIG. 4 in conjunction with FIG. 5, if a search term 94 is “music player”, the matching brands 202 may include the brand name available in a brand subcategory 58d linked to the music player subcategory 58c. Further, if the search term 94 is “music” rather than “music player” the matching brands may be broader and include the brand name of: i) each brand available in a brand subcategory 58d linked to the music player subcategory 58c; ii) brand names associated with music related sub categories linked to any other higher level category 58a (e.g. brand names associated with music related sub categories under automotive, current events, education, electronics, entertainment, etc); and ii) any other brand name with data associations within the search database 35 indicating that such brand is associated with music or associated with a product or service associated with music.

Matching products 204 may comprise a product summary 214a, 214b, 214c for each product that associates with any of the search terms 94 entered by the user. More specifically, matching products 214 may comprise a product summary 214a, 214b, 214c for any product with a name or other data association within the search database 35 which indicates that such product or service is associated with any search term 94.

Each product summary 214a, 214b, 214c may comprise a thumbnail 216a, 216b, 216c respectively of the product, identification of the product name, an overall rating of the product (which may be aggregated from consumer video reviews), and identification of the number of consumer video reviews available for such product.

Again, those products that include a more relevant association with a search term 94, an association with multiple search terms 94, or higher probability of association with a search term 94 may be depicted more prominently within the matching products 204. Alternatively, placement of a product name within the matching products 204 may be a monetization event 36 (FIG. 1) and an advertiser(s) (or merchant(s)) 27 (FIG. 1) associated with a product may pay to have a particular product depicted more prominently within matching products 204 for certain search terms.

As an example, referring to FIG. 4 in conjunction with FIG. 5, if a search term 94 is “music player”, the matching products 204 may include the product name of each product within the product subcategory 58d under the music player subcategory 58b. Again, if the search term 94 is “music” rather than “music player” the matching products may be broader and include the product name of: i) each product subcategory 58d under the music player subcategory 58b; ii) products names associated with music related sub categories under any other higher level category 58a (e.g. brand names associated with music related sub categories under automotive, current events, education, electronics, entertainment, etc); and ii) any other product name with data associations within the search database 35 indicating that such product is associated with music or associated with a product or service associated with music.

The categorization of the search results 173 as matching videos 200, matching brands 202, and matching products 204 may be for purposes of more effectively delivering the information content (video product reviews 93) desired by the user. More specifically, at the time the user enters a search term(s) 94, it is not known whether the user desired information content (e.g. video product reviews 93) about a particular product class, a particular product, or a particular brand. For example, at the time the user enters a search term 94 (such as music), it is not known whether the user desires information content related to music players (categorized under Electronics) or, for example, local concerts which may be categorized under Current Events and/or Entertainment.

As such, the video summaries 201 provided as part of matching videos 200 may be the product reviews that best match the search terms 94 entered by the user—regardless of product class, product, brand, or other classification.

The matching brands 202 and matching products 204, by nature of listing a brand name or a product name, provide the user with a more effective means for obtaining desired information content and/or obtaining relevant video product reviews 93 for browsing and/or viewing.

For example, if the user entered a search term of “music” with the intent of finding information about MP3 music players, he or she may select a brand known to relate to MP3 music players from the matching brands 202 or a particular MP3 player product. Alternatively, if the user entered a search term of “music” with the intent of finding information about an upcoming local concert, he or she may select a brand known to be the provider of the local concert from the matching brands 202—or identification of the local concert.

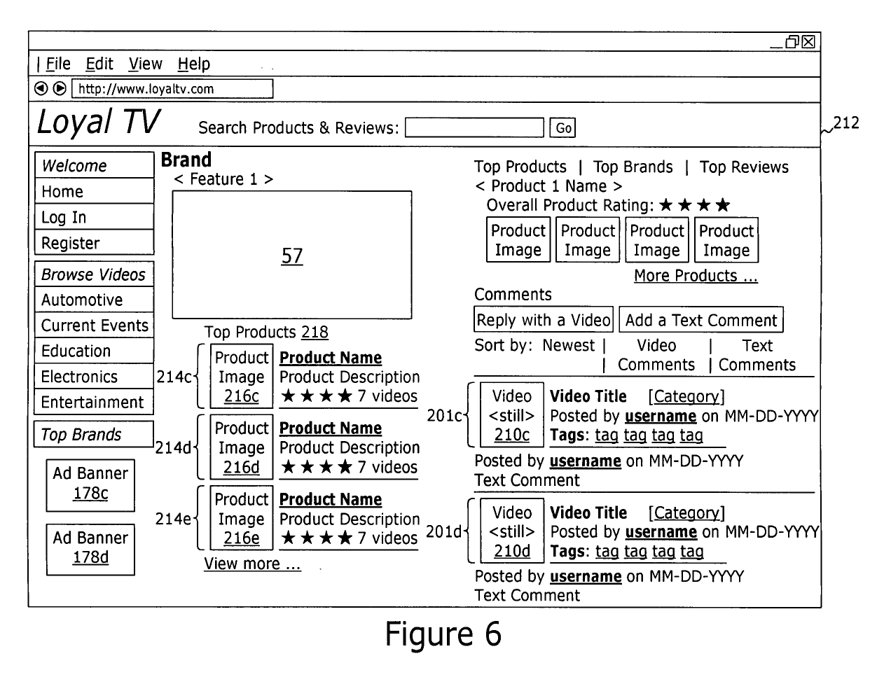

In the event that a user selects one of the brand names of the matching brands 202, a search results web page 212 based on the brand may be rendered to the searching consumer as depicted in FIG. 6. The search results web page 212 may include a video rendering 57 of a selected video product review 95—which is selected in accordance with the teachings of the present invention. The video rendering 57 may be provided by a feed provider module 55 (FIG. 1) upon identification of the particular selected video product review (e.g. video product review of highest priority) by the search module 24.

The brand search results page 212 may also include a products section 218 including a product summary 214c, 214d, 214e for any product available under the brand name—and associated therewith in the search database 35 which indicates that such product or service is associated with any search term 94.

Again, each product summary 214c, 214d, 214e may comprise a thumbnail 216c, 216d, 216e respectively of the product, identification of the product name, an overall rating of the product (which may be aggregated from consumer video reviews), and identification of the number of consumer video reviews available for such product.

Other selected video product reviews may also be represented by a review summary 201c, 201d within the brand search results page 212. Again, the selected product reviews may be selected in accordance with the teachings of the present invention.

The exemplary brand search results web page 212 may further include at least one ad placement 178c, 178d.

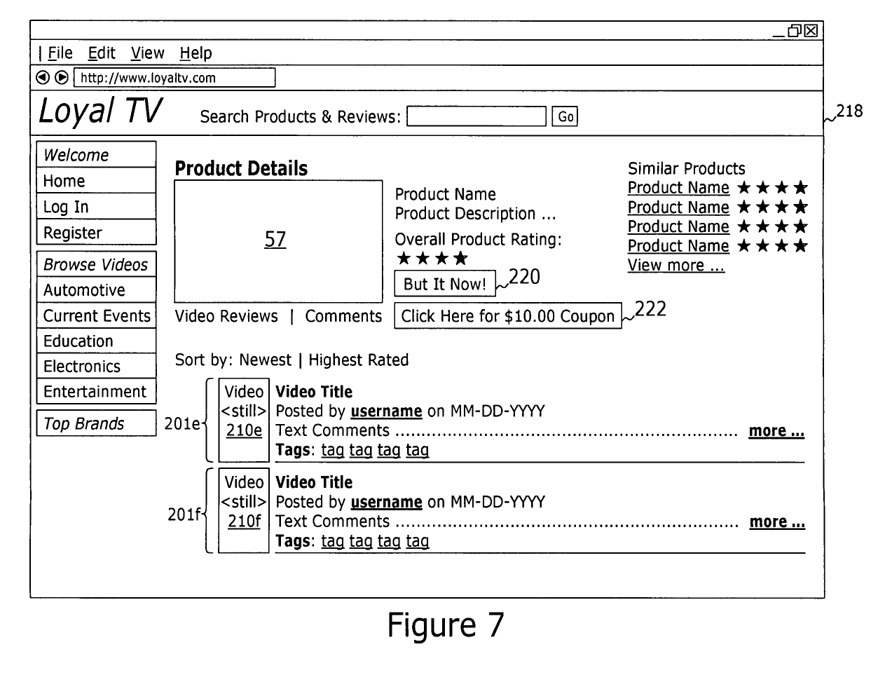

Similarly, in the event that a user selects one of the products from either the search results page 170 or the brand search results page 212, a product search results page 218, as depicted in FIG. 7, may be provided to the searching consumer. The product search results page 218 may include a rendering 57 of a selected video product review 95 chosen in accordance with the present invention based on effectiveness of the review and/or characteristics of the review.

The product search results page 218 may also include review summaries 201e, 201f related to the product. The product search results page 218 may also, for example, include a merchant or advertiser's purchase offer in the form of a specific price “buy it now” offer 220 and/or a electronic coupon 222 specifying a discount.

Again, the exemplary product search results page 218 may further include at least one ad placement 178a- 178b. Selection of advertisement content for rendering in each ad placement 178a, 178b is discussed in more detail herein.

Returning to FIG. 1, for purposes of monetizing the aggregate wisdom of consumers, a monetization module 26 may associate monetization events 36 with operation of the system 10 and, more specifically, to user searching, browsing, and viewing of relevant video product reviews 95. Upon each occurrence of each monetization event 36, the monetization module 26 may debit an associated monetization amount from an advertiser or merchant's account 49 to a house account 39 for obtaining compensation (e.g. revenue 33) from advertisers and merchants 27.

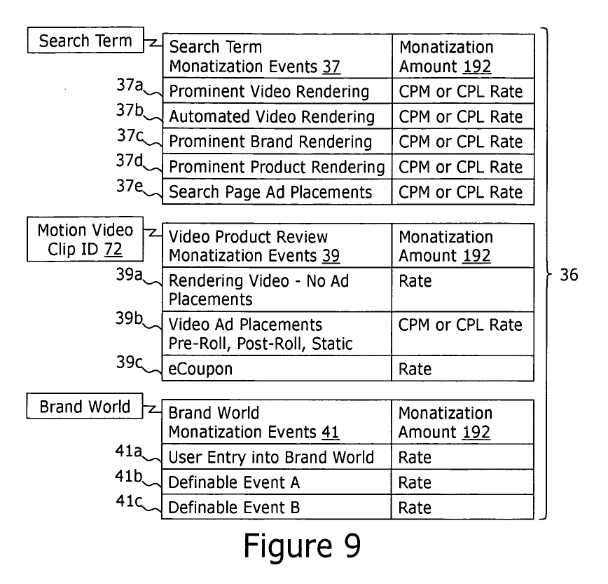

Turning to FIG. 9, monetization events 36 may classified as search term monetization events 37, video review monetization events 39, and brand world monetization events 41.

In general, search term monetization events 37 may be monetization events associated with particular search term(s) 94 that a user may enter when searching, browsing, and viewing relevant product reviews 95. Video product review monetization events 39 may be events associated with the rendering of a particular video product review to a user. Brand world monetization events 41 may be monetization events associated with user participation in defined premium interaction with a brand world area 25 (discussed herein).

Turning to FIG. 5 in conjunction with FIG. 9, an exemplary search term monetization event 37a may comprise rendering summary items 201 for a particular video product review 93 in a prominent position within the matching videos 200—for example as the first summary item 201—in response to user entry of a particular defined search term. For example, an advertiser may pay to have a video product review 93 that is an extremely favorable endorsement of the advertiser's brand or product placed prominently when a user enters a search term associated with such brand or product.

A second exemplary search term monetization event 37b may comprise rendering of a particular video product review 93 (e.g. a default feed of the motion video clip on a brand, product, or other search results page)—in response to user entry of a particular defined search term. Again, an advertiser may pay to have a video product review 93 that is an extremely favorable endorsement of the advertiser's brand or product automatically rendered in response to user entry of a search term associated with such brand or product.

A third exemplary search term monetization event 37c may comprise rendering of a particular brand name in a prominent position within the matching brands 202 in response to user entry of a particular defined search term. An advertiser may pay to have its brand name rendered prominently in response to user entry of a search term associated with the advertisers brand or product.

A fourth exemplary search term monetization event 37d may comprise rendering of a particular product in a prominent position within the matching products 204 in response to user entry of a particular defined search term. An advertiser may pay to have its product rendered prominently in response to user entry of a search term associated with the advertisers brand or product.

A fifth exemplary search term monetization event 37e may comprise rendering of advertisement content within an ad placement on a brand, product, or other search results page 170, 212, 218 in response to user entry of a particular defined search term. An advertiser may pay to have its own advertisement content rendered prominently on a brand, product, or other search results page 170, 212, 218 in response to user entry of a search term associated with the advertisers brand or product.

An exemplary video product review monetization event 39a may comprise rendering of a particular video product review 93 with no competitive ad placements. An advertiser may pay to have a video product review 93 that is an extremely favorable endorsement of the advertiser's brand or product rendered without advertisement placement (or without competitive advertisement placement) when rendered. This event 39a differs from event 37b in that the monetization event 37b relates to when a particular a video product review 93 is automatically rendered, this event 39a relates to how a video product review 93 is rendered (e.g. rendered without advertisement placements).

A second exemplary video product review monetization event 39b may comprise rendering of advertisement content as an advertisement placement associated with a particular video product review 93. Exemplary advertisement placements include a pre-roll, a post roll, and static advertisement placements rendered in close proximity to the video product review. An advertiser may pay to have its advertisement content rendered in association with a particular video product review 93 for the advertiser's own product or other product related to the advertiser's products or brands.

A third exemplary video product review monetization event 39c may comprise delivery of a customized offer to a consumer such as delivery of an electronic coupon 222 (FIG. 7) that may be used at the advertiser's point of sale or presentation of a buy it now price offer 220 (FIG. 7) if the user can be linked to a web store front to purchase a particular product on-line.

Returning to FIG. 1, for further purposes of monetizing the aggregate wisdom of consumers, a highly configurable interaction area 25 (e.g. a brand world) may be purchased and configured by an advertiser 27 for customized premium interaction 29 with consumers 18 linking to such interaction area 25 for purposes of publishing brand information, implementing contests, and/or implementing other means for obtaining information from consumers and or making customized offers to consumers.

Returning to FIG. 9 in conjunction with FIG. 1, various events associated with the consumer participating in premium interaction 29 may be defined as brand world monetization events 41.

For example, brand world monetization event 41 a may comprise the consumer linking to the brand world 25. An advertiser configuring a brand world 25 may pay simply to have a user linked to the brand world 25 from other web pages within the system 10. Other brand world monetization events 41b, 41c are each definable based on the configuration of the advertiser's brand world 25 and related to user participation in premium interaction such as completing a survey, participating in a contest, interacting with on-line customer services bots or representatives. It should be appreciated that these brand world monetization events are exemplary only and that other monetization events are anticipated within the scope of the present invention.

Returning to FIG. 1, as discussed, the occurrence of monetization events 36 provide revenue 33 from advertisers to a house account 39 associated with the operator of the system 10. It is further recognized that a portion of such revenue 33 may be utilized for facilitating efficient operation of the system 10 by encouraging and rewarding desirable consumer interaction with the system 10.

More specifically, a rewards module 38 may associate a consumer reward 45 with each of a plurality of reward events 43. A reward event 43 may be any event which is desirable for a consumer to perform for purposes of achieving the objectives of aggregating, distributing, and monetizing the collective wisdom of consumers. Reward events 43 may correlate to monetization events 36 or be other target events. Upon the occurrence of a reward event 43, a reward 45 with monetary value (e.g. cash reward and/or point reward redeemable for cash or items of cash value) may be generated and credited to a consumer account 53 for ultimate payment to the consumer 18.

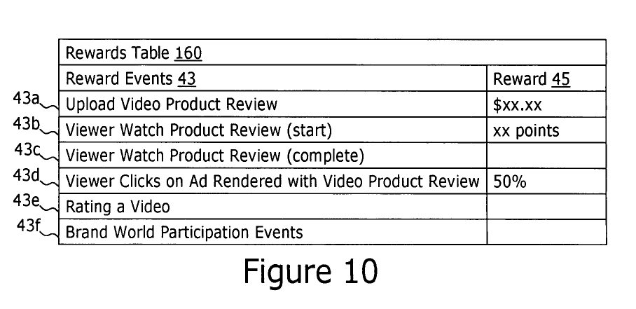

Turning briefly to the rewards table 160 of FIG. 10 in conjunction with FIG. 1, exemplary reward events 43 may comprise: i) uploading a video product review 93 (event 42a); ii) a viewer selecting the registered consumer's uploaded video product review for viewing (event 43b); iii) a viewer viewing the registered consumer's uploaded video product review to the end (event 43c); iv) a viewer clicking on an advertisement impression rendered in conjunction with the registered consumer's uploaded video product review 93 (event 43e); v) rating a video uploaded by another registered consumer (event 43e); vi) participating in a survey, contest, or custom other consumer data collection activity configured by a brand or other product/service provider (e.g. a brand world participation event 43f).

Each of the reward events 43 may be associated with a monetary reward 45 which may be any of a designated monetary and/or point amount (for example, $xx.xx for xx points uploading a motion video clip) or a percentage of a monetary amount associated with a corresponding monetization event (for example 50% of the monetary amount associated with the monetization event of the viewer clicking of the advertisement).

As such, the combination of the functions of the aggregation module 22, the functions of the search module 24, the functions of the feed provider module 55, monetization events 36, and reward events 43 provide an efficient system and method for aggregating, distributing, and monetizing the collective wisdom of consumers and, more particularly for collecting consumer video product reviews, categorizing video product review content, associating video product review content with monetization events, and distributing video product review content.

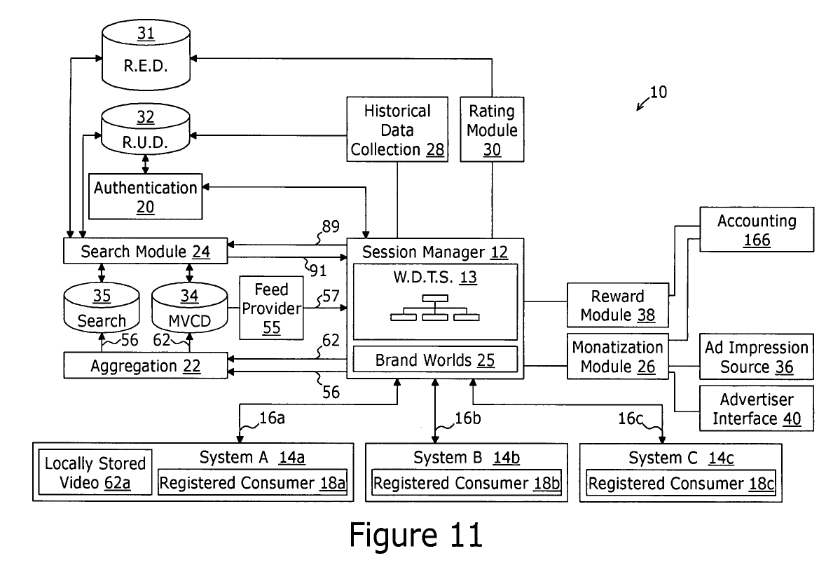

FIG. 11 represents a more detailed block diagram of the networked system 10 for collecting, aggregating, distributing, and monetizing the collective wisdom of consumers. The system 10 comprises, as discussed with respect to FIG. 1, the aggregation module 22, the search module 24, the motion video clip database 34 and the search database 35. Further, for purposes of operating the system 10 as discussed, the system 10 may include a session manager 12, an authentication module 20, a registered user database 32, an affectivity database 31, a historical data collection module 28, a rating module 30, a monetization module 26, and a rewards engine 38. Each of such components interacts for providing the

The session manager 12 functions as a web server in that it establishes and maintains, with each of a plurality of client systems 14a, 14b, 14c, an internet connection 16a, 16b, and 16c therewith. Through each internet connection 16a, 16b, 16c, a registered consumer (represented by boxes 18a, 18b, and 18c) is authenticated (e.g. user name and password passed to the authentication module 20 and matched to a user name and password in the registered user database 32) and the session 16a, 16b, 16c becomes uniquely associated with its registered consumer 18a, 18b, 18c.

The session manager 12 comprises a web document template structure 13 which includes a plurality of interlinked web document templates. In operation, the session manager 12 provides, to each registered consumer 18a, 18b, 19c, a sequence of web documents (populated web document templates) in accordance with the user's position within the web document template structure 13 (e.g. in accordance with the user's selection of web documents available from the user's then current position).

### Aggregation Module

As discussed, the purpose of the aggregation module 22 is to obtain a plurality of motion video clips 62 for storage in the motion video clip database 34. The aggregation module may further, for each such motion video clip 62, obtain identification of initial content descriptors 74 (including product categorization data 56) of the video product review 93 for association with the motion video clip 63 in the search database 35.

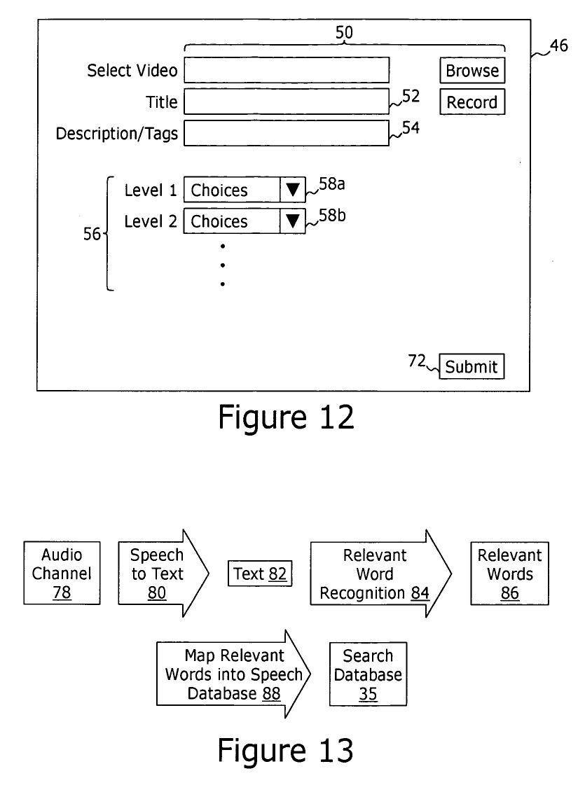

Referring to FIG. 12 in conjunction with FIG. 11, an upload video web document 46 may be provided to the end user (for example registered consumer 18a) through the session 16a therewith upon the a registered consumer 18a selecting a menu choice (not shown) to upload a video within one of the web documents of the web document template structure 13.

The exemplary upload video web document 46 comprises: i) a motion video clip upload control 50 for browsing and selecting a locally stored motion video clip file (for example 62a) for upload to the system 10 (or alternatively may include a record motion video clip record control which, when selected, streams real time video to the system 10 instead of selecting a locally stored video clip); ii) a title control (which may be a free text box) for obtaining a registered consumer identified title for association with the motion video clip; iii) a tag control 54 (which may be a free text box) for obtaining register user identified text tags for association with the motion video clip; and iv) and a plurality of categorization data controls 56. The categorization data controls 56 may be combinations of menu controls 58a, 58b (such as drop down menu controls or pop-up menu controls) and selection boxes 60 for obtaining user selection of categorization data elements 61 which the registered consumer determines the motion video clip best fits. The categorization data elements 61 may include the predefined categories and subcategories that correspond to categories and sub categories 58a-58d as discussed with respect to FIG. 3 and FIG. 4—and which.

For example, returning briefly to FIG. 4 in conjunction with FIG. 12, the menu control 58a may comprise menu choices 70a representing a first level (e.g. highest level) categorization which distinguishes products by product class or industry (for example, automotive, electronics, travel etc).

The menu control 58b may comprise menu choices 70b, 70c representing a second level of categorization underneath the first level classification of “Electronics” and “Travel” respectively. As discussed, menu choices 70b which subcategorize “Electronics” may include sub categorizes such as cameras, cell phones, computers, music players, and etc). Menu choices 70c which subcategorize “Travel” may include sub categories such as airlines, cruises, and etc.

As such, a video product review (for example video product review 63a of FIG. 2), may be: i) classified under “Electronics” by virtue of the user selecting “Electronics” using drop down menu control 58a; and ii) sub classified under “Music Players” by virtue of the user selecting “Music Players” using drop down menu control 58b.

Similarly the exemplary video product review 63b of FIG. 2 may be: i) classified under “Travel” by virtue of the user selecting “Travel” using drop down menu control 58a; and ii) sub classified under “Cruises” by virtue of the user selecting “Cruises” using drop down menu control. Although FIG. 12 depicts only two levels of categorization, it is envisioned that other levels of categorization may further subcategorize by company, brand, make, model, and/our source of the product.

A submit or post control 72 may initiate posting of the motion video clip 62 and the categorization data elements 56 to the system 10 through the session 16a. In response to such posting, the aggregation module 22 may implement functions for storing the motion video clip 62 in the motion video clip database 34 and writing the categorization data elements 56 to applicable fields of the search database 35.

It should also be appreciated that although exemplary operation of the aggregation module 22 comprises use of the upload video web document 46 for obtaining user input of the content descriptors 74, content descriptors 74 may be obtained on an automated basis.

For example, referring briefly to FIG. 13 in conjunction with FIG. 11 the aggregation module 22 may, for an uploaded motion video clip 62, derive content descriptors 74 by: i) capturing an audio channel 78 of a motion video clip 62; ii) performing a speech to text conversion function 80 on an audio channel 78 to generate a text representation 82 thereof; ii) performing a word recognition process 84 for recognizing relevant words 86 (words useful for population into the search database 35 as content descriptors 74); and iii) performing a mapping function 88 to map the relevant words into the search database 35.

### Search Module

Returning to FIG. 11 the search module 24, as discussed, accepts user entered search term(s) 94 for purposes of enabling a user to search, browse, and view video product reviews 63. As discussed, the search term(s) 94 may be compared to content descriptors 74 within the search database 35 (FIG. 3) and each video product review 93 (identified by motion video product review ID 72) associated with content descriptors 74 matching the user entered search term(s) 94 may be classified as a relevant video product review 95.

More generally, the purpose of the search module 24 is to identify a selected group of video product reviews 63. The selected group of video product reviews is/are a portion of the plurality of motion video clips stored in the motion video clip database 34 which are relevant video product reviews 95.

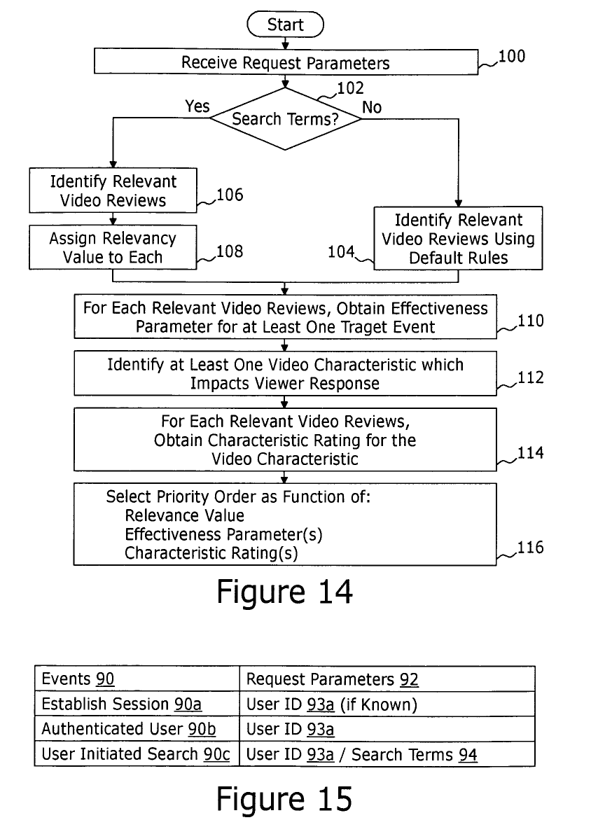

A flow chart depicting exemplary steps performed by the search module 24 is depicted in FIG. 14. Turning to FIG. 14, in conjunction with FIG. 11 step 100 represents the search module 24 obtaining the request parameters 92 as part of a request 89 from the session manager 12.

Turning briefly to FIG. 15 in conjunction with FIG. 11, various events 90 occurring during a session (for example session 16b) may be used to initiate a request 89 to the search module 24. For example: i) a first event 90a may be the session 16b first being established, a request 90 may be initiated for purposes of obtaining a video to include on the initial log in page; ii) a second event 90b may be the registered consumer being authenticated (e.g. authentication of user name and password) a request 92 may be initiated for purposes of obtaining a video clip to render on the main-menu page displayed following authentication; and iii) a third event 90c may be the user initiating a search and providing search terms—which may include user selection of predetermined categories, subcategories, brands, makes, models sources, or free text entry of search terms.

Each request 89 may include passing of request parameters 92 to the search module 24 (or use of default request parameters 92 by the search module if none are passed as part of the request 89). For example, a request 89 in response to first establishing a session (event 90a), the request parameters 92 may include the User ID 93 if determinable (for example if a cookie on the local system 14b can be read or the IP address of the session can be read to predict that the session is being established for a particular registered consumer 18b).

The request parameters 92 for a request 89 in response to authenticating a registered consumer (event 90b) may include the user ID 93. And, the request parameters 92 for a request 89 in response to a registered consumer initiating a search (event 90c) may include the user ID 93 and at least one search term 94 entered by the user.

Returning to FIG. 14, decision box 102 represents determining whether the request 89 includes search term(s) 94. If search term(s) 94 are not included, the search module 24 may utilize default rules for selecting one or more relevant motion video clips 91. In one example where the identification of the user is unknown, default rules may select: i) motion video(s) most viewed; ii) newly uploaded motion video(s); and/or iii) motion video(s) identified by other characteristics—such as a motion video most likely to induce a predetermined action on the part of the user.

In one example where the identification of the user is known, default rules may select: i) motion video(s) most viewed by users within a same demographic and/or behavioral class as the identified user; and/or ii) motion video(s) matching pre-selected categorization or subject matter criteria identified by the user (using steps similar to steps 106-110 discussed below).

Alternatively, if at step 102, search term(s) 94 are included in the request 89, such search term(s) 94 may be applied to product categorization data elements 74 of the search database 35 (FIG. 3) for purposes of identifying relevant motion video clips 95—as represented by step 106. For example, the search term(s) 94 entered by the user and included in the request 89 may identify a make, model, or brand of a product—or a type of a product. Such search term(s) 94 will be used to identify motion video clips relevant thereto.

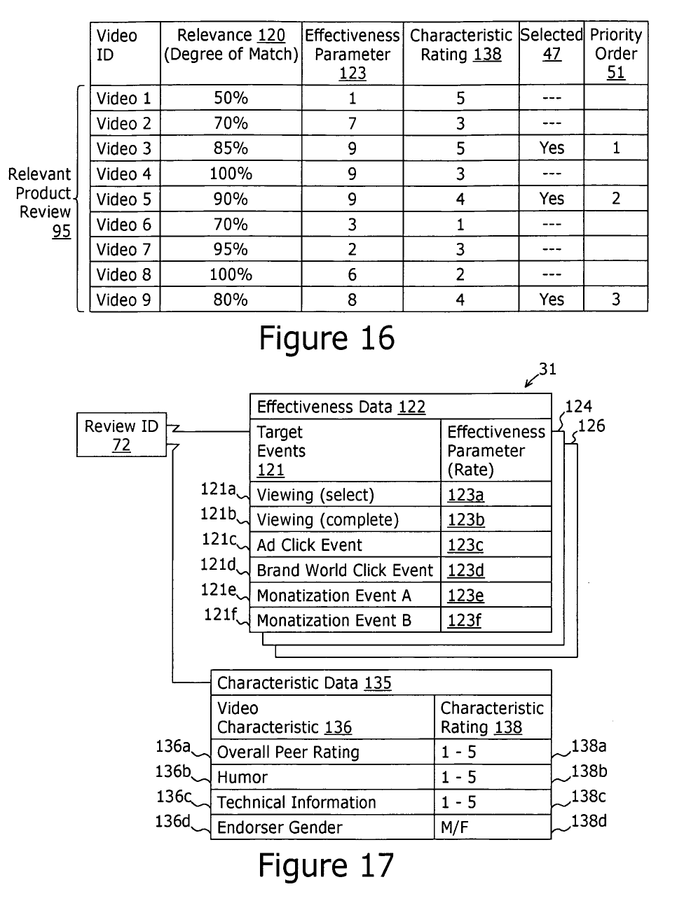

Step 108 represents assigning a relevancy value to each identifying motion video clip. Turning to FIG. 16 in conjunction with FIG. 14, in one embodiment a relevancy value 120 represents the degree of match between the search term(s) 94 and the product categorization data elements 74 (e.g. the quantity of matches or other measurement of the degree of match).

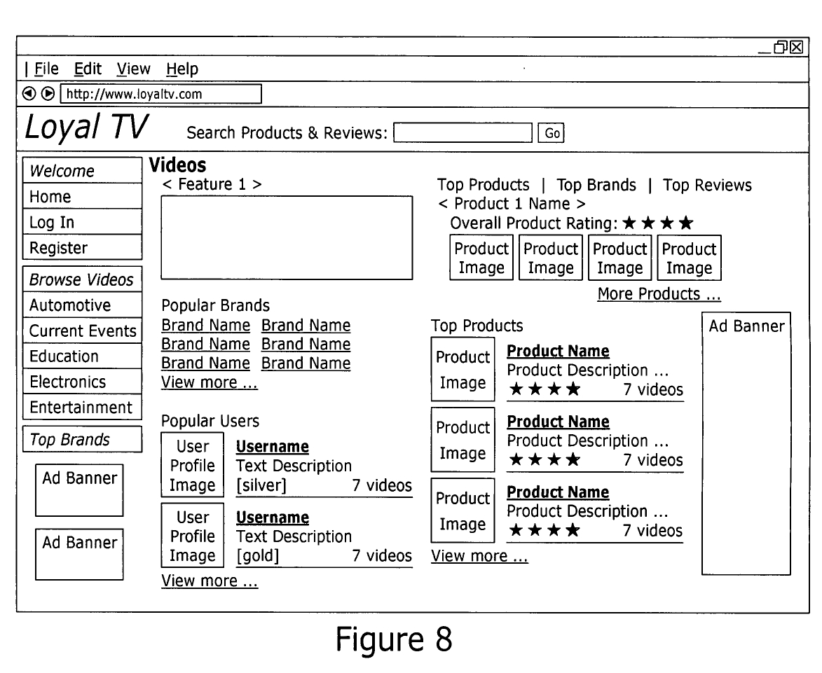

After identifying relevant video product reviews 95 any of the search pages depicted in FIG. 5, FIG. 6, FIG. 7, and FIG. 8 may be populated. However, to provide for more effective distribution and monetization, selected motion video clips may be further identified from the relevant motion video clips, and a priority order selected, by further evaluating the relevant video product reviews 95 in view of: i) how effective the video has been at inducing a target event; ii) the viewer's responsiveness to characteristics of the video; and iii) values associated with various monetization events 36 (FIG. 9).

As such, step 110 represents obtaining at least one effectiveness parameter value 122 for each relevant motion video clip. A high video effectiveness score may indicate that the motion video clip 62 is effective at inducing a target event more frequently than a video with a lower effectiveness score. Target events may include any event that the viewer may perform that is beneficial to operation of the system for aggregating, distributing, and monetizing the collective wisdom of consumers. Target events may be monetization events 36 (FIG. 1).

Turning briefly to FIG. 17 in conjunction with FIG. 11, an review effectiveness database 31 may associate each motion video clip (identified by its motion video product review ID 72) with effectiveness data 122 indicating how effective the motion video clip is at inducing each of a plurality of target event 121 which, as discussed, include any event that the viewer may perform that is beneficial to operation of the system for aggregating, distributing, and monetizing the collective wisdom of consumers. In more detail, each target event 121 is associated with an effectiveness parameter 123 which is a measure of how frequently the motion video clip inducts the target event.

For example, target event 121a may be user selection of the motion video clip for viewing (when presented with a group of related videos) and the effectiveness parameter 123a may indicate a frequency at which such event occurs. Similarly, target event 121b may be a user viewing the motion video clip to completion and the effectiveness parameter 123b may indicate a frequency at which such event occurs as a following user selection to view the clip (event 121a).

Event 121c may be an ad click event such that effectiveness parameter 123c is an indication of how frequently users click on an advertisement rendered with the video (for example how frequently users click on an advertisement for a product depicted in the video). Event 121d may be a brand world click event such that effectiveness parameter 123d indicates how frequently users link to a brand world 25 when presented with such option in conjunction with rendering of the video. Events 121e and 121f may represent other monetization events associated with the motion video clip and the effectiveness parameters 123e and 123f measure the frequency of the occurrence of such monetization events respectively.

As depicted in FIG. 17, the review effectiveness database 31 may store effectiveness data 122 on a global bases (e.g. the effectiveness parameters 123 a value determined by measurement across all registered consumers). Further, the review effectiveness database 31 may further store effectiveness parameter values 123 for each target event 121 by mutually exclusive subgroups of users. Users may be subdivided into mutually exclusive sub groups based on demographic and/or behavioral patterns. For example, table 124 may store effectiveness parameter values 123 for each target event 121 for only female registered consumers (e.g. values determined by measurement across only female registered consumers) while table 126 may store effectiveness parameter values 123 for each target event 121 for only male registered consumers (e.g. values determined by measurement across only male registered consumers). Other mutually exclusive subgroups may be based on other demographic and/or behavioral data.

FIG. 16 depicts the search module 24 associating (at step 110 of FIG. 14) at least one effectiveness parameter 123 for at least one target event 121 with each of the relevant motion video clips 95.

Returning to FIG. 14, step 112 represents identifying at least one video characteristic to which the viewer is responsive. Each relevant video product review 95 includes its expression of the user's opinion, technical information or other wisdom information with a content, style, and/or communication characteristics or communicator characteristics which, when present in a video product review 95, have been determined to be more favorable to the user (or more frequently induce a favorable response by the user) than when not present in a video product review 95.

For example, if it is determined that a person responds measurably more favorably to a video product review 95 with a high technical information rating than a video product review 95 with a low technical information rating, the user is responsive to a technical information rating and a video product review 95 that has a high technical information rating correlates well with such viewer's response characteristics. Similarly, if it is determined that a person responds measurably more favorably to a video product review 95 with a high humor rating than a video product review 95 with a low humor rating, the user can be determined to be responsive to a humor rating and a video product review 95 that has a high humor rating correlates well with such viewer's responsiveness.

Briefly returning again to FIG. 17, the review effectiveness database 31 may further store, in association with each motion video clip (identified by motion video product review ID 72) characteristic data 135 comprising, for each of a plurality of video characteristics 136, a characteristic rating 138 which is a rating or measurement of the extent to which the video characteristic 136 is present within the motion video clip.

For example, a first video characteristic may be an overall peer rating characteristic 136a and the characteristic rating 138a may be an average of the rating (on a scale of 1 to 5) assigned to the motion video clip by registered consumers previously rating the video clip. A second video characteristic may be humor 136b and the humor characteristic rating 138b may be an average of the rating (on a scale of 1 to 5) of how much humor registered consumers perceived in the video clip. Similarly, a third video characteristic may be technical information content 136c and the technical information characteristic rating 138c may be an average of the rating (on a scale of 1 to 5) of how other registered consumers perceived the value of technical information content depicted in the video clip. A fourth video characteristic may by the endorser's gender 136d and the characteristic rating 138d may be a M/F selection identifying the endorser's gender.

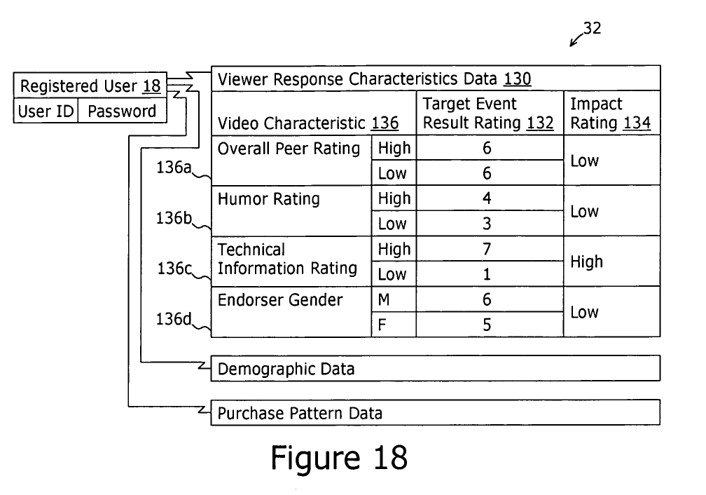

Turning briefly to FIG. 18, a registered consumer database 32 may comprise data tables storing, for each registered consumer (identified by registered consumer ID 93), viewer response characteristic data 130. The viewer response characteristic data 130 comprises, for each of the plurality of video characteristics 136a-136d , target event result rate data 132 which is a measure of the frequency at which a target event is achieved as a function of the characteristic rating of the video characteristic 132.

For example, for a particular user, the target event result rating data 133 for the characteristic of overall peer rating 136a indicates that such characteristic does not significantly alter the frequency at which the target event is induced in this particular user (e.g. target event occurs at the same frequency (indicated by rating of “6”) regardless of whether the overall peer rating is high or low). However, for this particular user, the target event result rating data 133 for the characteristic of technical information rating 136c indicates that such characteristic does significantly alter the frequency at which the target event is induced in this particular user (e.g. target event occurs at a much higher frequency for motion video clips rated high for technical information). As such the user can be referred to have a high sensitivity, or be highly responsive, to the characteristic 134.

As such, returning to FIG. 14, step 112 represents utilizing data stored in the registered consumer database 32, and more particularly to the viewer response characteristic data 130 stored in association with the viewer in the registered consumer database 32 to identify those video characteristics 136 to which the user is sensitive or to which the user is highly responsive.

Step 114 represents, for each relevant motion video clip, obtaining the characteristic rating 138 (FIG. 17) and associating, as depicted in FIG. 16, the such characteristic rating 138 with each of the relevant video product reviews 95.

Referring to FIG. 16 in conjunction with FIG. 14, Step 116 represents determining selected product reviews and/or a priority order for the relevant video product reviews 95 as a function of: i) the relevance 120, ii) the effectiveness parameter 123 for at least one target event 121 (FIG. 17); iii) the characteristic rating 138 (FIG. 17) for at least one video characteristic 136 to which the user is responsive 134 (FIG. 18).

More specifically, determining the selected video product reviews and/or a priority order of those relevant video product reviews 95 may comprise selecting those relevant video product reviews 95 with: i) an effectiveness parameter 123 greater than a predetermined or minimum threshold value; and/or ii) for a characteristic to which the view is responsive (high impact rating 134 (FIG. 18)) a characteristic rating 138 greater than a predetermined or minimum threshold value.

For example, referring again to FIG. 17, those relevant video product reviews 95 which meet both criteria, for example an effectiveness parameter 123 greater than “7” and a characteristic rating 138 greater than “4”, may be selected video product reviews 47. The priority order 51 may be, for example, an order based on the highest combination of the effectiveness parameter 123 and the characteristic rating 138 of those selected video product reviews 47.

### Monetization Module

Returning to FIG. 11 in conjunction with FIG. 9, the purpose of the monetization module 26 is to: i) associate a plurality of monetization events 36 with each search term, video product review, and brand world premium interaction event; ii) associate a monetization amount 192 with each monetization event 36; and iii) record the occurrence of each monetization event 36 and its associated monetization amount 193 in an accounting system 166 for purposes of assuring that the advertiser 27 is correctly charged.

Each monetization event may be sold utilizing typical means for selling advertisement placements within a web content. Such methods comprise selling of the monetization events (including those monetization events which comprise impression based or click based advertisement placements) to advertisers through direct negotiation and contract and/or selling of the impression based or click based advertisement impressions through a broker and/or online advertisement placement system operating as a broker between advertisers and websites with available ad placement inventory (e.g. advertisement impression source 36).

For example, for purposes of utilizing an advertisement impression source 36, the monetization module 26 may feed key words associated with the motion video clip (for example the text tags) to an advertisement impression source 36 which runs a continuous auction for advertisement placements associated with such key word. In response, the monetization module 26 will receive advertisement content for rendering within an advertisement placement from the advertisement placement system. Upon either rendering of the impression, or the user clicking to link through to the advertiser's web site, the monetization amount 193 will be paid by the advertisement placement system.

In one aspect, the monetization event 36 may include obtaining, through a real time advertiser interface 40, a real time individual offer to the viewer such as the “buy it now” offer 220 specifying a specific price or the “electronic coupon” offer 222 specifying a discount, both as discussed with respect to FIG. 7.

### Historical Data Collection Module

Returning to FIG. 11, the purpose of the historical data collection module 28 is to capture and record effectiveness data 122 (FIG. 17) for each motion video clip 62 stored in the motion video clip database 34 and to capture and record user response characteristic data 130 (FIG. 18) for each registered consumer 18a, 18b, and 18c.

As discussed with respect to FIG. 17, exemplary effectiveness data 31, for each motion video clip (identified by its motion video product review ID 72), may comprise an effectiveness parameter 123 value for each of a plurality of target events 121. Each effectiveness parameter 123 may represent how frequently the motion video clip induces occurrence of the target event 123 (for example a monetization event). For example, a viewing rate parameter 123a may indicate how frequently user's select the video for viewing when presented with a group of related videos (for example as depicted in FIG. 5, FIG. 6, FIG. 7, or FIG. 8). A complete viewing rate parameter 123b may indicate how frequently the entire motion video is viewed (to the end) after a user selects the video and starts viewing. A click rate parameter 123c may indicate how frequently user's click on an advertisement rendered with the video (for example how frequently users click on an advertisement for a product depicted in the video.

As depicted in FIG. 17, the review effectiveness database 31 may store parameter values for each effectiveness parameter 121 on a global bases (e.g. a value determined by measurement across all registered consumers). Further, the review effectiveness database 31 may further store parameter values for each effectiveness parameter for subgroups of users. For example, table 124 may store the effectiveness data values for female registered consumers (e.g. values determined by measurement across only female registered consumers) while table 126 may store the effectiveness data values for male registered consumers.

As discussed with respect to FIG. 18, the registered consumer database 32 may comprise data tables storing, for each registered consumer 18, response characteristic data 130. The response characteristic data 130 comprises, for each of the plurality of video characteristics 136a-136d, target event result rate data 132 which is a measure of the frequency at which a target event is achieved as a function of the characteristic rating of the video characteristic 132.

In operation, the historical data collection module 28 monitors the occurrence of each target event and, upon its occurrence, the historical data collection module may obtain the video characteristics 136 for the video being viewed and update the target event result rate 132 and the impact rating 135 which, as discussed is the impact of the characteristic on the consumer's responsiveness 134.

### Rating Module

Returning to FIG. 16 in conjunction with FIG. 11, the purpose of the rating module 30 is to obtain user characteristic ratings 138 for each of the video characteristics 136. It is envisioned that, for each motion video clip, if characteristic ratings 138 are achieved from a sufficient quantity of registered consumers, the aggregate rating will be sufficiently accurate.

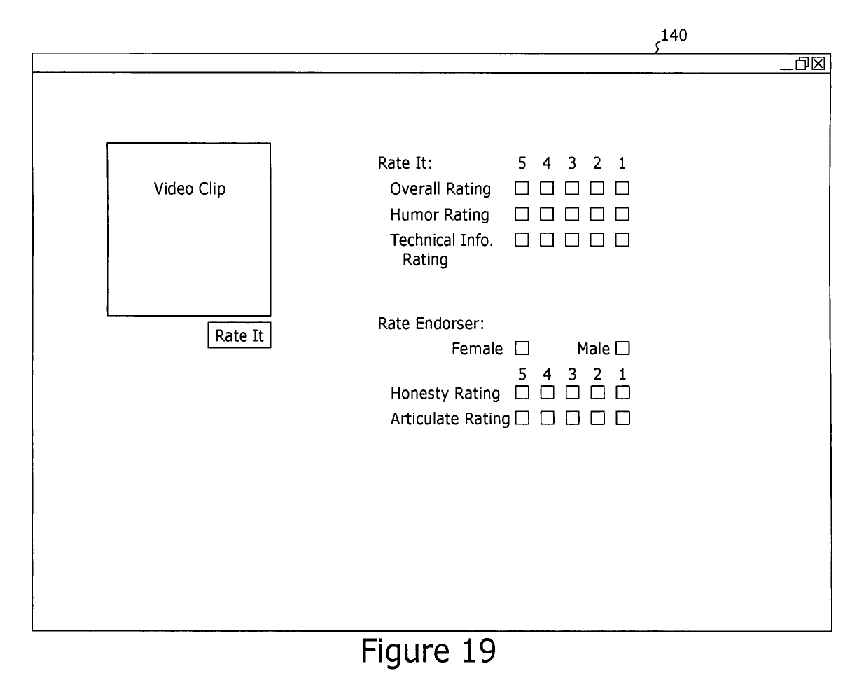

In more detail, with brief reference to FIG. 19, when a registered consumer selects a menu choice associated with rating a motion video clip (or acquiesces to an invitation to rate a motion video clip), a rating video web document 140 may be provided to the registered consumer.

The rating video web document 140 may comprise controls for obtaining the user's rating of the motion video clip being rendered 142 within the document 140—or, more particularly, with reference to FIG. 11 in conjunction with FIG. 17, for obtaining the video characteristic data 135 for population into the review effectiveness database 31.

It is envisioned that if the characteristic data 135 is obtained from sufficiently large number of user's rating the video, it will accurately represent the characteristic of the motion video clip.

The rating data that may be obtained may comprise: i) an overall rating; ii) a humor rating, and ii) a technical information rating. Specific rating information about the person endorsing the product in the video may comprise: i) identification of the endorser's gender (note, use of the rating page is a covenant means for obtaining this video characteristic data—although it could be automatically obtaining utilizing image recognition systems); ii) the user's perception of the endorser's honesty; and iii) the user's perception of the endorsers ability to clearly articulate a message.

Upon posting of the registered consumer's responses to the rating questions back to the session manager 12, the rating module 30 may log such responses as part of the characteristic data 135 of the effectiveness data 31. Logging such responses may comprise directly storing the responses as effectiveness data 31 or updating the characteristic ratings 138 associated with the motion video clip to include the response data (for example recalculating an average of all responses to yield a updating characteristic crating 138).

### Reward Engine

The purpose of the reward engine 38 is to maintain a reward account 53 for each registered consumer 18 and, upon the occurrence of certain reward events 43, credit such registered consumer's account. It is envisioned that operation of the system for aggregating, distributing, and monetizing the collective wisdom of consumers may operate more effectively if registered consumers are enticed to participate in certain events and/or provide certain data (e.g. a reward event) through a monetary reward system.

As discussed with respect to FIG. 10, the rewards table 160 associates each of a plurality of exemplary reward events 160 and a monetary value 162 which may be any of a designated monetary and/or point amount (for example, $xx.xx for xx points uploading a motion video clip) or a percentage of a monetary amount associated with a corresponding monetization event (for example 50% of the monetary amount associated with the monetization event of the viewer clicking of the advertisement).

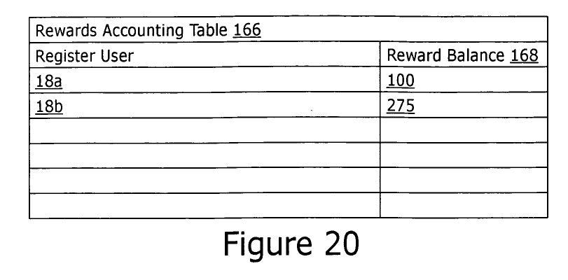

Turning briefly to FIG. 20 in conjunction with FIG. 1, the reward engine 38 may maintain reward accounting data 166 for each registered consumer 18. The reward accounting data 166 may comprise a reward balance 168 which is credited upon the occurrence of a reward event 162 (FIG. 10) and debited upon the registered consumer redeeming rewards. Historical reward event and redemption data may also be stored. Although the accounting data 166 is represented as an independent component in FIG. 11, it is envisioned that the accounting data 166 may be a component of the registered consumer database 32.

Although the invention has been shown and described with respect to certain exemplary embodiments, it is obvious that equivalents and modifications will occur to others skilled in the art upon the reading and understanding of the specification. For example, the data relationships represented in various figures are exemplary only. Those skilled in the art will appreciate that database design for implementation may utilize other data relationships to achieve the objectives of the present invention. The present invention includes all such equivalents and modifications, and is limited only by the scope of the following claims.

What is claimed is:

1. A networked system for collecting, aggregating, and distributing the collective wisdom of consumers, the networked system comprising:
a web server for establishing a plurality of internet connections, each with a client system;
an authentication module associating each internet connection with one of a plurality of registered consumers;
an aggregation module for obtaining, from each of a plurality of reviewing consumers:
a file comprising a motion video clip depicting a video product review of a product; and
the reviewing consumer's indication of at least one categorization data element identifying the product;
a motion video clip database storing each motion video clip;
a search database storing, for each motion video clip, the at least one product categorization data element identifying the product depicted in the motion video clip;
a search module receiving a search term associated with a searching consumer and identifying a selected group of video product reviews, the selected group of video product reviews comprising those video product reviews that are a relevant video product review, wherein a relevant video product review comprises a video product review that is associated with a product categorization data element corresponding to the search term; and
a monetization module debiting a first predetermined value from a merchant's account upon each occurrence of a target event, the target event comprising the searching consumer initiating interaction with a link associated with web content comprising additional information about the product depicted in the video product review;
wherein each of the plurality of reviewing consumers are a registered consumer; and
wherein the searching consumer is a registered consumer.

2. The system of claim 1, wherein the web server further provides a search results web page to the searching consumer, the search results web page comprises at least two distinct search result listings;
a first of the at least two distinct search results listings comprising identification of at least a portion of the selected group of video product reviews; and
a second of the at least two distinct search results listing comprising one of:
identification of a plurality of brand names associated with the search term; and
identification of a plurality of product names associated with the search term.

3. The system of claim 1, wherein the web server further provides a search results web page to the searching consumer, the search results web page comprises at least three distinct search result listings;
a first of the at least three distinct search results listings comprising identification of at least a portion of the selected group of video product reviews; and
a second of the at least three distinct search results listings comprising identification of a plurality of brand names associated with the search term; and
a third of the at least three distinct search results listings comprising identification of a plurality of product names associated with the search term.

4. The system of claim 1, further comprising a rewards module, the rewards module crediting a second predetermined value to the reviewing consumer's account upon occurrence of the target event.

5. The system of claim 4, wherein the link is associated with an advertisement placement for the product depicted in the video product review.

6. The system of claim 4, wherein the target event is the searching consumer initiating purchase of the product depicted in the reviewer's video product review by interaction with a link associated with a merchant's purchase offer, the reviewer's video product review being a video product review uploaded by the reviewing consumer.

7. The system of claim 6, wherein the link associates with a merchant's purchase offer comprises one of: i) a buy it now offer specifying a price; and ii) an electronic coupon offer specifying a discount.

8. The system of claim 1, further comprising:
a review effectiveness database storing, for each video product review; at least one effectiveness parameter identifying a frequency at which the video product review, when viewed by registered consumers, induces occurrence of the target event; and
the selected group of video product review comprises those video product reviews which are both a relevant video product review and an effective video product review; and
wherein an effective video product review comprises a video product review that is associated with an effectiveness parameter identifying that the video product review induces the target event with a frequency greater than a threshold frequency.

9. The system of claim 8, wherein the link is associated with an advertisement placement for the product depicted in the video product review.

10. The system of claim 8, wherein the target event is the searching consumer initiating purchase of the product depicted in the reviewer's video product review by interaction with a link associated with a merchant's purchase offer, the reviewer's video product review being a video product review uploaded by the reviewing consumer.

11. The system of claim 10, wherein the link associates with a merchant's purchase offer comprises one of: i) a buy it now offer specifying a price; and ii) an electronic coupon offer specifying a discount.

12. The system of claim 8:
further comprising a registered user database storing, in association with identification of each of the plurality of registered consumers, viewer response characteristic data, the viewer response characteristic data identifying at least one video characteristic which, when present in a video product review viewed by the registered consumer, induces the registered consumer to take an action resulting in occurrence of the target event with a greater frequency then when the video characteristic is not present;
the review effectiveness database further stores, in association with each video product review, a characteristic rating parameter identifying an extent to which the video characteristic is present in the video product review; and
where the selected group of video product reviews comprises those video product reviews that are both a relevant video product review and an effective video product review and further are associated with a characteristic rating parameter indicating that the extent to which the video characteristic is present in the video product review is above a predetermined threshold.

13. The system of claim 12, wherein the characteristic rating parameter is a value representative of at least one other registered consumer's opinion of the extent to which the video characteristic is present in the video product review.

14. The system of claim 12, wherein the characteristic rating parameter is a value representative of an opinion, of at least one other registered consumer selected from a subgroup consisting of only a portion of the plurality of registered consumers that are demographically similar to the searching consumer, of the extent to which the video characteristic is present in the video product review.

15. A networked system for collecting, aggregating, and distributing the collective wisdom of consumers, the networked system comprising:
a web server for establishing a plurality of internet connections, each with a client system;
an authentication module associating each internet connection with one of a plurality of registered consumers;
a motion video clip database storing a plurality of files, each comprising a motion video clip depicting a video product review of a product;
a search database storing, for each video product review, at least one product categorization data element identifying the product;
an review effectiveness database storing, for each video product review; at least one effectiveness parameter identifying a frequency at which the video product review, when viewed by registered consumers, induces occurrence of a target event;
a search module receiving a search term associated with a first of the registered consumers and identifying a selected group of video product reviews, the selected group of video product reviews comprising those video product reviews that are both a relevant video product review and an effective video product review;
wherein a relevant video product review comprises a video product review that is associated with a product categorization data element corresponding to the search term; and
wherein an effective video product review comprises a video product review that is associated with an effectiveness parameter identifying that the video product review induces the target event with a frequency greater than a threshold frequency.

16. The system of claim 15, wherein the web server further provides a search results web page to the searching consumer, the search results web page comprises at least two distinct search result listings;
a first of the at least two distinct search results listings comprising identification of at least a portion of the selected group of video product reviews; and
a second of the at least two distinct search results listing comprising one of:
identification of a plurality of brand names associated with the search term; and
identification of a plurality of product names associated with the search term.

17. The system of claim 15, wherein the web server further provides a search results web page to the searching consumer, the search results web page comprises at least three distinct search result listings;
a first of the at least three distinct search results listings comprising identification of at least a portion of the selected group of video product reviews; and
a second of the at least three distinct search results listings comprising identification of a plurality of brand names associated with the search term; and
a third of the at least three distinct search results listings comprising identification of a plurality of product names associated with the search term.

18. The system of claim 15, wherein the target event is the searching consumer selecting, for viewing, a reviewers video product review, the reviewers video product review being a video product review uploaded by the reviewing consumer.

19. The system of claim 15, wherein the target event is a viewer of the video product review initiating interaction with a link associated with a web content comprising additional information about the product depicted in the video product review.

20. The system of claim 19, wherein the link is associated with an advertisement placement for the product depicted in the video product review.

21. The system of claim 15, wherein the target event is a viewer of the video product review initiation purchase of the product depicted in the video product review by interaction with a link associated with a merchant's purchase offer.

22. The system of claim 21, wherein the link associates with a merchant's purchase offer comprises one of: i) a buy it now offer specifying a price; and ii) an electronic coupon offer specifying a discount.

23. The system of claim 15:
further comprising a registered user database storing, in association with identification of each of the plurality of registered consumers, viewer response characteristic data, the viewer response characteristic data identifying at least one video characteristic which, when present in a video product review viewed by the registered consumer, induces the registered consumer to take an action resulting in occurrence of the target event with a greater frequency then when the video characteristic is not present;
the review effectiveness database further stores, in association with each video product review, a characteristic rating parameter identifying an extent to which the video characteristic is present in the video product review; and
where the selected group of video product reviews comprises those video product reviews that are both a relevant video product review and an effective video product review and further are associated with a characteristic rating parameter indicating that the extent to which the video characteristic is present in the video product review is above a predetermined threshold.

24. The system of claim 23, wherein the characteristic rating parameter is a value representative of at least one other registered consumer's opinion of the extent to which the video characteristic is present in the video product review.

25. The system of claim 23, wherein the characteristic rating parameter is a value representative of an opinion, of at least one other registered consumer selected from a subgroup consisting of only a portion of the plurality of registered consumers that are demographically similar to the searching consumer, of the extent to which the video characteristic is present in the video product review.

26. A networked system for collecting, aggregating, and distributing the collective wisdom of consumers, the networked system comprising:
a web server for establishing a plurality of internet connections, each with a client system;
an authentication module associating each internet connection with one of a plurality of registered consumers;
an aggregation module adapted for obtaining, from each of a plurality of reviewing consumers, a file comprising a motion video clip depicting subject matter related to a merchant's product;
a motion video clip database storing each motion video clip;
a search database storing, for each motion video clip, at least one product categorization data element identifying the subject matter related to the merchant's product depicted in the motion video clip;
a search module receiving a search term associated with a searching consumer and identifying at least one relevant motion video clip, wherein the relevant motion video clip comprises a motion video clip that is associated with a product categorization data element corresponding to the search term; and
a monetization module adapted for:
associating a monetization value with a first target event, the first target event comprising a searching consumer viewing the motion video clip comprising subject matter related to the merchant's product;
debiting the monetization value from a merchant's account upon each occurrence of the first target event; and
a rewards module crediting a reward value to an account of the reviewing consumer upon each occurrence of the first target event, the reward value being less than the monetization value.

27. The system of claim 26, wherein:
the monetization module is further adapted for:
associating a second monetization value with a second target event, the second target event comprising the searching consumer initiating interaction with a link associate with web content comprising additional information about the merchant's product;
debiting the second monetization value from the merchant's account upon each occurrence of the second target event; and
the rewards module crediting a second reward value to the account of the reviewing consumer upon each occurrence of the second target event, the second reward value being less than the second monetization value.

28. The system of claim 27, wherein the link is associated with an advertisement placement for the merchant's product.

29. The system of claim 26, wherein:
the monetization module is further adapted for:
associating a second monetization value with a second target event, the second target event comprising the searching consumer initiating purchase of the merchant's product by interaction with a link associated with a purchase offer of the merchant;
debiting the second monetization value from the merchant's account upon each occurrence of the second target event; and
the rewards module crediting a second reward value to the account of the reviewing consumer upon each occurrence of the second target event, the second reward value being less than the second monetization value.

30. The system of claim 29, wherein the link associates with the purchase offer comprises one of: i) a buy it now offer specifying a price; and ii) an electronic coupon offer specifying a discount.
